(19) United States
(12) Patent Application Publication
(10) Pub. No.: US 2002/0157034 A1
(43) Pub. Date: Oct. 24, 2002

(54) Data streaming system substituting local content for unicasts

(75) Inventor: Richard Bryan Sagar, Santa Clara, CA (US)

Correspondence Address: Michael E. Schmitt, Corporate patent Counsel, U.S. Philips Corporation, 580 White Plains Road, Tarrytown, NY, 10591, US

(73) Assignee: Koninklijke Philips Electronics N.V.

(21) Appl. No.: 09/792,145

(22) Filed: Feb. 21, 2001

(51) Int. Cl. H02H 3/05

(52) U.S. Cl. 714/4

(57) ABSTRACT

Bandwidth is saved in Internet radio transmission, by substituting content locally stored at the client for unicast content. The unicast content is then omitted from the transmission. The locally stored content is mixed with studio content from the Internet radio station. Control data within a content stream instructs the listener's client to use the locally content together with the studio content. The studio content, recorded content for which local content can be substituted, and the control data are separately compressed prior to transmission. The locally stored content can be provided from a jukebox module or another source on the home network. The transmission and reception techniques are applicable to any type of streamed media, including video.

### BACKGROUND OF THE INVENTION

A. Field of the Invention

The invention relates to the field of streaming content information over a data network such as the Internet. The invention relates especially, but not exclusively, to “Internet Radio”.

B. Related Art

Internet Radio involves streaming data content from a server over the Internet to a listener. Sometimes, data may be downloaded in advance to a listener cache for faster playback later. However, since the term “Internet radio” is commonly used in the art, it will be used here as well. Typically the content for the Internet radio station will include voice and music. The voice may be that of a disk-jockey (DJ) or other studio chatter.

Real-time streaming of content is effected by programs such as RealAudio™ produced by RealNetworks, Inc. This streaming is usually of highly compressed data content, to allow the audio to be received over dial-up connections in the consumer's home. The dial-up is typically less than 56kbit/s bandwidth, which means a very high compression ratio is required compared to the “original” CD source material (44.1ksample/s×16 bits/sample×2 channels).

Internet “radio stations” differ from traditional “broadcast” stations as the Internet-based station is not sent out as a broadcast stream. This means that each person who connects to the station connects to a unique socket and is delivered an independent “stream”—over UDP (User datagram protocol), TCP (transport control protocol), or RTP (real-time transport protocol). Consequentially the load on the server increases in proportion to the number of listeners who are accessing the station.

Also most radio stations play a select number of tracks in a day. These tracks are selected from a “playlist” which usually changes on a weekly basis. This means that over the space of a few days, much of the content is repeated.

Generally, Internet radio is compressed prior to transmission. This can result in a lossy transmission that is not of optimal sound quality.

### SUMMARY OF THE INVENTION

It is an object of the invention to reduce the bandwidth necessary for content streaming, and to improve the quality of experience for the user of streamed content.

These objects are achieved in that higher quality local content is substituted for a lower quality unicast.

Advantageously, the objects are achieved in that in the transmitter at least a first content stream and at least one descriptor are generated. The transmitter transmits either a first or second type of transport data. The first type of transport data includes the first and at least a second content stream and the descriptor. The first type of transport data is transmitted, e.g., by default or in response to a first type of user response indicating lack of user stored content corresponding to the second data stream. The second type of transport data includes the first content stream and the descriptor. The second type of transport data is transmitted in response to a second type of user response indicating presence of user stored content corresponding to the second data stream.

Currently, over ten thousand radio stations broadcast over the Internet. Listening to music via the Internet has become a popular pastime. Real-time streaming of audio over dial-up connections to the consumer's home requires a very high compression ratio compared to CD source material. Typically, radio content consists of music interspersed with monologues of the host. Radio is streamed over the Internet wherein each user gets a unique socket and is delivered an individual stream of data. As a result, the load on the server is proportional to the number of users. Most radio programs select tracks from a play list that gets changed on a weekly basis. That is, over few days much of the content is repeated. The inventor assumes that the play-out device has a storage for recorded music content, e.g., recorded in a previous download or present on a CD, so that only the music's identifier need to be sent. The device sends to the station that it is playing or has available a local copy or other substitute, so that the server only has to stream the voice of the host. Applied to the entire listener base this leads to a substantive reduction in bandwidth per user. The music could be trickled-in overnight onto the user's storage device to spread the bandwidth requirements over time and optimize the usage during typically popular time slots. Preferably, two separate channels are used for the host's voice and the music content to avoid caching music talked over by a DJ. If the user records the content streamed from the studio, the content's identifier or descriptor can be stored locally at the client as well as the music. The identifier thus can be saved as part of the control data that enables selecting from either content being streamed over the Internet or content stored locally, e.g., based on matching identifiers.

Incorporated by reference herein are the following:

U.S. Ser. No. 09/345,339 (attorney docket PHA 23,700) filed Jul. 1, 1999 for Mark Hoffberg et al., for CONTENT-DRIVEN SPEECH- OR AUDIO-BROWSER. This document relates to a method for categorizing web sites or resources on the Internet that provide audio (e.g., speech and music) streaming based on their typical content. A web resource that provides audio streaming is identified by its resource type. The resource type is determined by way of the type extension in its URL that indicates the file format, e.g., “.ram”, “.tsp” or “.swa”. This extension enables, for example, to automatically open the proper software applications (or “plug-ins”) in the user's browser when the hyperlink is clicked. Accordingly, the relevant resources on the Internet can be identified based on their URL. If the file extension is not available through the URL, the resource type is determined by the MIME type or content-type information provided in the HTTP header of the resource. Taking into consideration the resource's country domain extension, e.g., “.nl” for the Netherlands or “.ru” for Russia, further optimizes the analysis of the URL, for example if one is interested in audio content in a specific natural language. Upon finding a relevant resource, i.e., one that provides streaming of audio, the resource's file is retrieved from the relevant server and analyzed based on its audio content. Speech recognition or music (tune/rhythm) recognition software can be used to search through and categorize these stations by, e.g., language, style of music, absence of commercials. Speech recognition software is capable of determining the signature of various kinds of music, thus allowing categorization of music with just this kind of software. For example, classical music has typically a different speech recognition signature than rock music. A server can be dedicated to categorize stations or channels in a data base, similar as to what PlanetSearch or Altavista does for text documents. One or more web crawlers can be used in parallel to automatically fetch web sites that supply audio so as to identify them for a search engine. Additionally, the resource's server can be evaluated by the crawler for the quality of the connection, e.g., connection speed, reliability, etc. For example, the categorizing server may recommend to a user, who has broadband network access (e.g., ISDB, cable, T1), higher connection speed sources. An audio browser is provided, analogous to PlanetSearch's or Alta Vista's for text, to provide a searchable collection of Internet audio web sites based from which specific pages are returned to the user based on certain audio search criteria. Alternatively, the catalog approach (Yahoo experts hand-pick and assign sites to categories) can be taken to categorize the stations at the server and make them accessible through a search engine. Once the sites are categorized, a user provides a query input to the server and receives a list of URLs representative of the channels that match the query input (e.g., give me a French language station that plays music like this). As an alternative or supporting this, the server provides a customized electronic program guide to the user based on a profile of the user stored on the server, e.g., using the SmartConnect infrastructure of Philips Electronics.

U.S. Pat. No. 5,963,957 (Attorney Docket PHA 23,241) issued to Mark Hoffberg for BIBLIOGRAPHIC MUSIC DATA BASE WITH NORMALIZED MUSICAL THEMES. This patent document discusses, among other things, how rhythm information or tonal information of a musical theme can be used to identify the theme. The rhythm information comprises the time signature (meter) and the accentuations of the theme. The time signature determines the number of beats to the measure. The accentuation determines which beat gets an accent and which one does not. For example, the sign ⁶₈ in a musical score is the time signature indicating that the meter is 6 beats to the measure and that an eighth note gets one beat. Flamenco music has a variety of different styles, each determined by its own compàs (rhythmic accentuation pattern). Typical examples of flamenco music are Alegrias, Bulerìas, Siguiriyas and Soleares that all have 12 beats to the measure. In the Alegrias, Bulerìas and Soleares, the third, sixth, eighth, tenth and twelfth beats are accentuated. The first, third, fifth, eighth and eleventh beats are emphasized in the Siguiriyas style. In this system rhythmic accentuation patterns are used as input data in order to retrieve bibliographic information associated with the theme that is represented by the rhythm. For example, the rhythmic accentuation pattern is entered into the system as a substantially monotonic sequence of accentuated and unaccentuated sounds. The input data then is represented by, e.g., a sequence of beats or peaks of varying height in the time domain. The relative distances between successive peaks represent the temporal aspects of the pattern and the relative heights represent the accentuations in the pattern. The sequence of beats and rests in between is represented by a digital word. The words can be stored lexicographically to enable a fast and orderly retrieval. If tonal information and/or rhythm information can be used to identify individual musical themes, they can also be used to identify with more or less accuracy a certain style of music.

U.S. Ser. No. 09/433,257 (attorney docket PHA 23,782) filed Nov. 4, 1999 for Eugene Shteyn for PARTITIONING OF MP3 CONTENT FILE FOR EMULATING STREAMING. This document relates to splitting an electronic content file content file into multiple parts. Each part or segment requires a relatively short download time. Therefore, the play-out latency is determined by the download time of the first part. The size of the individual part can be determined by the communications bandwidth, e.g., through pinging for a latency-check. The client device/application receives control information about the content. This control information comprises, for example, information relating to the size and memory location of the whole file as well as of it parts at the server. If the client is not capable of processing split data, it proceeds with the traditional approach, i.e., downloads the whole file and then plays it out. In case the client is capable of processing parts of the content, it uses the relevant control information about the parts in order to continue downloading data, while playing. Data play-out, also called “rendering”, is computation-intensive, since it requires a plurality of decoding operations. Data download is bandwidth-intensive. Accordingly, simultaneous play-out and downloading do not significantly compete for the same system resources. This separation between downloading and processing can be efficiently used in a multi-process and/or multi-thread environment.

Further objects and advantages will become apparent in the following.

### BRIEF DESCRIPTION OF THE DRAWING

The invention will now be described by way of non-limiting example with reference to the following drawings.

FIG. 1 is a schematic diagram showing connection of listeners to an Internet Radio provider.

FIG. 2a shows apparatus for capture of studio added content.

FIG. 2b shows apparatus for organization of music signals appropriate to the invention.

FIG. 3 shows apparatus for transmission of content from the Internet radio station onto the Internet.

FIG. 4 shows apparatus at a receiving location for processing signals produced in accordance with FIG. 3.

FIG. 5 shows a flowchart describing operation of box 403 of FIG. 4.

FIGS. 6a, 6b, and 6c show a data format for use with the invention.

FIG. 7a shows a listener device according to the invention adapted for use with video and audio data.

FIG. 7b shows a transmitter device according to the invention adapted for use with video and audio data.

### DETAILED DESCRIPTION OF THE PREFERRED EMBODIMENTS

In general, throughout this description, if an item is described as implemented in software, it can equally well be implemented as hardware.

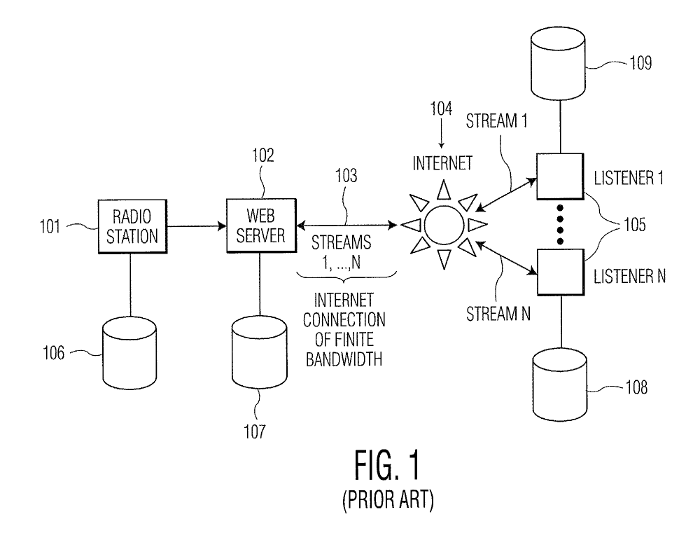

FIG. 1 is a schematic diagram of an Internet radio station. At 101 the creation of the audio content is shown. The station could be a traditional radio station, which is additionally providing content over the Internet, or it could be an Internet-only station. The content is transmitted to a web server 102 in a digitized and compressed format.

The web server manages requests from listeners and responds by providing them with a connection to the content of the station. This content is a continuous flow of bytes, which provides data at a constant rate (on average) and allows the content from the station to be conveyed to the listener. This flow of bytes is commonly referred to as a “stream”. And the term “streaming media” is used to describe content that is sent over the Internet in such a way.

From the web server 102, a number of transport streams of data 1 . . . N are provided via communications link 103 to the Internet 104. The connection could be of any suitable type, such as T1, T3, fiber-optic, and so forth. Each of these has a different potential throughput, but in all cases there is an upper limit to that throughput. The bandwidth of the transport streams 1 . . . N must satisfy the condition:

$${\sum }_{i = 1}^{N} bandwidth ( {stream}_{i} ) \leq {bandwidth}_{max}$$

In other words, the sum of the bandwidths of the individual streams must be less than the total bandwidth of the link 103. This total bandwidth limits the number of transport streams of data. Thus, if the bandwidths of the individual transport streams can be reduced, then the number of streams can be increased.

The web server 102 sends the transport streams out to the Internet addresses of the listeners, with each listener getting a respective stream. The term “unicast” will be used herein to indicate that each listener is provided with an independent connection, as opposed to “multicast”, or “broadcast”, which indicate that messages are sent from one node to many, or one node to all, respectively. Multicast and broadcast messages are not commonly used on the Internet, as there are problems with routing of the messages.

The Internet service provider 104 then separates out the transport streams 1 . . . N to the individual listener sites 105, which can also be thought of as transceivers. The terms “listener” and “user” herein are used to refer to the apparatus that receives the content, rather than to the actual human being who is listening.

The radio station 101 and each of the devices 102, and 105 has at least one local memory, 106, 107, 108 . . . , 109. The local memories 106-109 can be used for storing content or for storing software. The software may be for any number of purposes, including implementation of various aspects of the invention.

While the invention herein is described with respect to Internet radio, it is equally applicable to other streamed media systems, such as video systems, which can also use local content from a jukebox. An example of suitable local source for content in the video domain is a hard-disk based recorder, such as the Philips Tivo HDD-product.

Transmitting devices

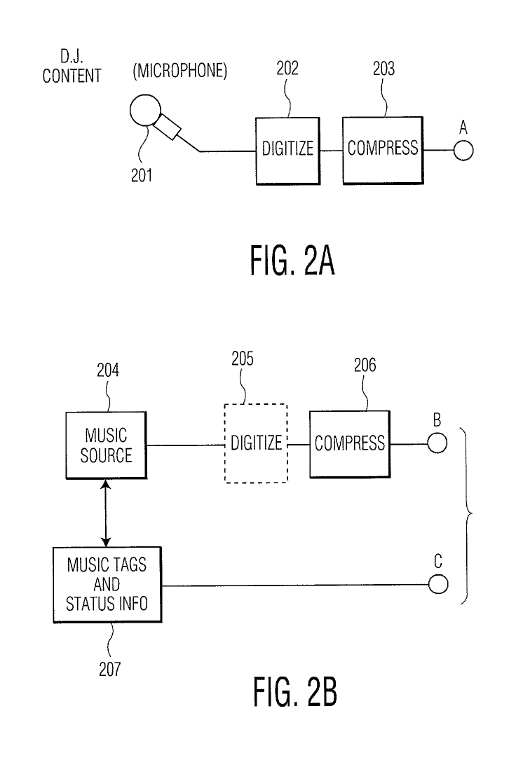

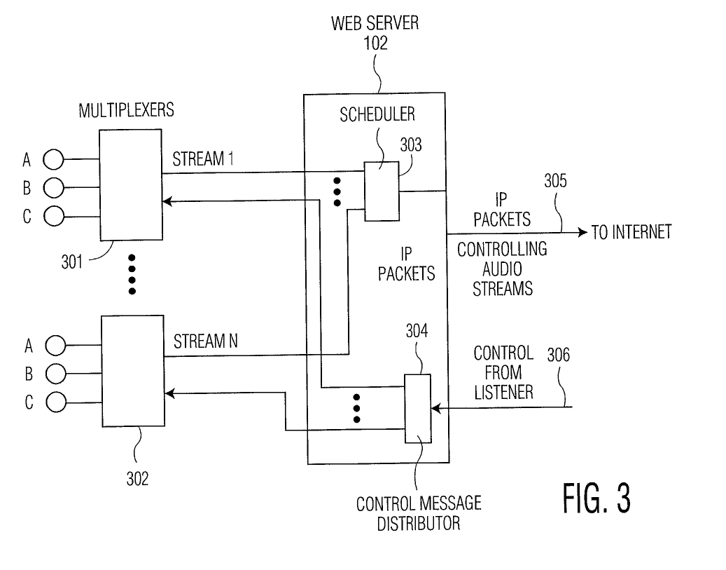

FIGS. 2a and 2b show a configuration of a radio station for providing content suitable for use with the invention.

In FIG. 2a the studio content is produced. Normally this will be a DJ speaking into a microphone 201, though other studio sounds can equally well be captured. Alternatively, recorded sounds, such as sound effects, might equally well be picked up or combined as part of the studio sounds. At 202, the studio sounds are digitized and then compressed at 203. The compressed digitized signals are then available at lead A. The format available at lead A might typically be Real Media format or Windows Media format, which are popular streaming formats used on the Internet to send content from radio stations. However, the skilled artisan might devise any number of suitable formats.

FIG. 2b shows circuitry associated with a music source 204. This music source 204 will typically be some item that is widely commercially available, such as a commercial CD or cassette tape. At 205 the music is digitized if necessary. Digitization is not always necessary—and hence shown in a dotted box—because many music recordings, for instance CD's, are already digitized. At 206 the music is compressed.

In the prior art, the combined studio and music contents would have been compressed together, while according to the invention they are compressed separately. The compressed, digitized music is provided at lead B. Additionally, tags for the music and additional information, such as status information, useful to the invention, are produced at 207 and provided at lead C.

The “Music Tag & Status Info” is meta-information about the information content of music source 204. In the case of a CD, this will be an identifier comprising the “CD ID”. The ID is something that is obtained from (or generated using) the disc being played, as is done with the CDDB catalogue that exists on the Internet (see, e.g., http://cddb.org for a description). In addition to the CD ID preferably the track number from the disc is used to provide a unique identifier for the song being played. Other status information would include

the elapsed time of the track (so that the local playback can be synchronized and substituted for the streamed content); and

Playback speed change information (to give the station flexibility to slightly modify the playback speed of the music, to aid mixing with other content or fitting a song into the time available, etc.).

In the case that the music is provided from a source other than CD, then the station will normally create its own identifier tags. It will then typically be necessary to distinguish between a tag unique to this station and a CD identifier. This latter category of content might, for instance, be a news report, an interview, a “studio session” of a musician or even commercials. By tagging the content, it is possible to instruct the remote listener's apparatus to cache the content the first time it is received. Then, over the course of the next few hours, days or months, the content does not need to be streamed from the station to this particular apparatus.

The three signals supplied at A, B, and C are sent to the web server as three components.

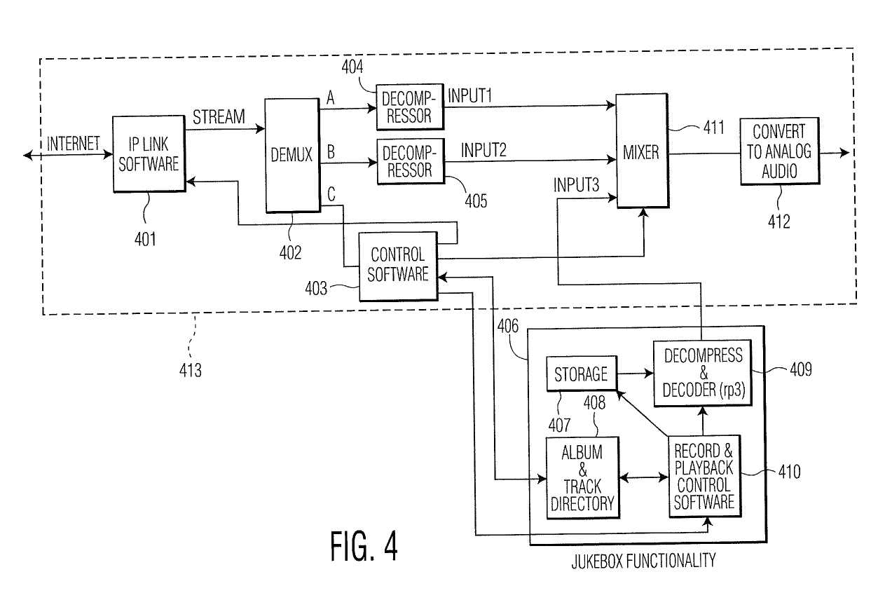

FIG. 3 shows apparatus feeding signals to and from the web server. While the multiplexer elements are shown as separate from the web server, and also separate from the components of FIGS. 2a & b, in fact all of the items on FIGS. 2 and 3 could be co-resident on a server, except for, perhaps, the actual microphone and the Internet itself. Similarly, various components could be combined into functionalities of a single processor, as a matter of design choice by the skilled artisan.

A multiplexer or other suitable controller 301 takes signals A (DJ content) and C (tags), and optionally B (music content), output from the circuitry of FIG. 2a and 2b to create a single transport data stream “Stream 1”. The various components of the combined stream can be transmitted using a protocol such as MPEG4. Whether B is included or not will depend on the control signals from the listener provided to the control message distributor 304.

The scheduler 303 can be implemented in software that takes a number of components (of arbitrary types) and “multiplexes” them into a single byte stream. The three components are tagged, such that they can be “de-multiplexed” at the remote end. This can be done in accordance with the MPEG4 standard, or any other similar method devised by the skilled artisan.

There are a total of N multiplexers 301 . . . 302, producing N streams of data. These can be implemented as separate modules, as shown, or as a single processor performing the N combining operations.

The inputs A, B, and C might be identical for each data stream N. Alternatively, the studio might mix more customized data streams for different listeners. For instance, there might be more than one DJ, each with a distinctive style, or even different musical selections.

The multiplexers 301 . . . , 302 also receive a control signal, passed via control message distributor 304 in the web server 102. This control signal comes from the user and will typically indicate whether or not input B can be omitted, if the listener has a local copy of the currently playing music. The control message distributor does this as follows:

Extract the Command and Listener Identifier from the message sent from listener to server.

Select the multiplexer that is creating the stream that the listener is receiving

Send the Command to the multiplexer, to control the streams that the multiplexer is multiplexing

In the case of the audio only program, valid commands would be: “Send Streams A+C” and “Send Streams A+B+C”.

The Streams (Stream 1 . . . , Stream N) coming from the multiplexers 301 . . . 302 are passed into the scheduler portion 303 of the web server 102. Scheduler 303 has the task of formatting the streams into the appropriate format for transmitting over the Internet at 305. Typically this requires

adding the IP (internet protocol) addresses of the destination,

putting the stream into the payload of a TCP or UDP packet,

handling the acknowledgement of transmissions,

checking for link drop-outs, and

multiplexing and load balancing the different streams that need to be sent to different listeners

An example of a server suitable for performing these functions can be found at http://apache.org. The apache web server is a public-domain Web server, based on the NCSA http Web server. It was developed from existing NCSA code plus various patches. It was called a patchy server, hence the name Apache Server.

Additionally the control message distributor 304 of the web server 102 has to deal with other requests 306 coming back from the listeners, such as the request to drop or add the (B) channel into the data stream, or to start or stop a stream. The web server then passes those commands onto the multiplexer software elements, using standard protocols, such as active server technology, a servlet interface or a CGI interface.

Listener device

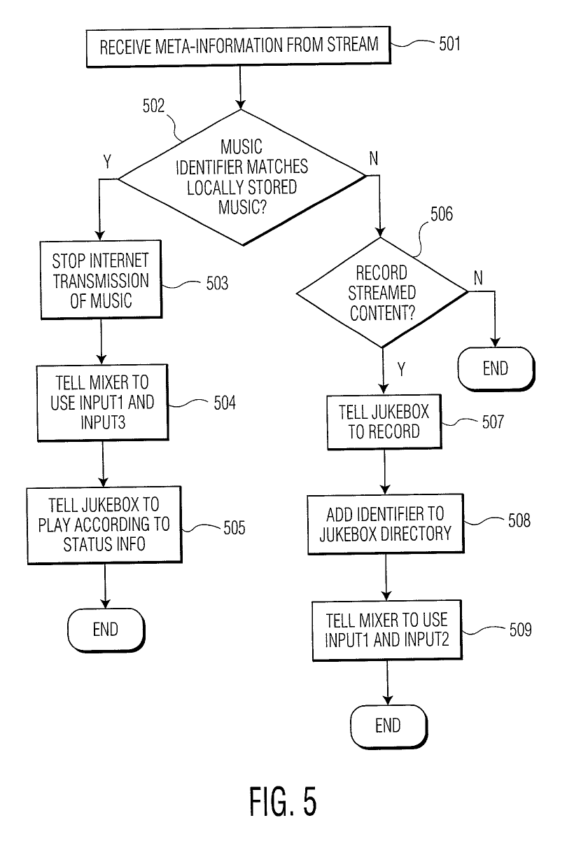

FIG. 4 shows the components that make up the listener 105. There are two major sections to the listener: 1) the functionality 413 required for receiving streamed content and converting back to analog, and 2) The functionality 406 required for implementing the audio jukebox. Stand-alone prior art products for these two sections are: Real Player™ by RealNetworks, Inc., for the reception of streaming content; and Real Jukebox™ by RealNetworks, Inc., to provide Jukebox functionality. Box 406 shows functionality present in an audio jukebox that is shown as disposed within a streaming media player in order to implement the invention. The audio jukebox functionality 406 can also be situated in another separate device (or program) that is controllable by the streaming media player, e.g., through a home network or proprietary bus. Generally, it is preferable to create linkage between the two products, rather than duplicate the jukebox functionality within the streaming media player and require that the music catalogue and track index be imported from the existing jukebox into the streaming media player.

In the Windows environment, it is commonly known that one application can expose its functionality for inclusion within another, through the mechanism know as COM (Component Object Model). Similar functionality is available on other platforms, and indeed cross-platforms, through the use of technologies such as SOAP (Simple Object Access Protocol), Java Beans and CORBA (Common Object Request Broker Architecture). In the consumer electronics space, one might rely on HAVi to provide the linkage between the jukebox and the streaming device. HAVi would use uploaded Java code from device to device, to expose the functionality of one device to the other.

Advantageously, the jukebox functionality may be programmable to refuse to record streamed media content. For instance, if the Internet radio station seeks to record advertising material for later playback by the user, the user might want to refuse to accept such recordings as taking up unnecessary space in the jukebox memory. Also, the quality of the content coming from the station will generally not be as high as that of the content normally in the possession of the user, and the user might not want low quality content recorded in the jukebox.

There is other functionality involved in the Jukebox, that is not shown in this diagram in order to not obscure the drawing—for instance, the block that converts the digital data back to analog audio, or hardware/software for implementing a user interface for the jukebox.

In the prior art, streaming receivers and audio jukeboxes are popular mainly as software components on a PC. However, it is possible for both to be made as stand-alone hardware, e.g., traditional consumer electronic devices. In both cases it is possible that two separate products could be used together to implement the invention, or the two products could be combined into a new product. Again the combined product could either be a software application that runs on a processor or it could be stand-alone hardware, such as a more traditional consumer electronic device.

The IP link software 401 is a standard component that connects this device to the Internet, such that the data stream can be received over the IP network. It may include such components as a modem, PPP (Point-to-Point) link, etc. It allows requests to be sent out, such as to allow the device to connect to a station and to allow the control for the multiplexing of the three signal components (A), (B) and (C), as described for FIGS. 2 and 3.

The demultiplexer, or demux, 402 takes the content stream from the Internet, which contains the three components (A), (B) and (C), plus the details about how to separate them from the stream. An article about a multiplexing scheme that would be suitable for use here is found at http://www.cselt.it/ufv/leonardo/paper/isce96.htm#Multiplexing_and_Synchronization_of_AVO s further information on this topic can be found at http://mpeg.org.

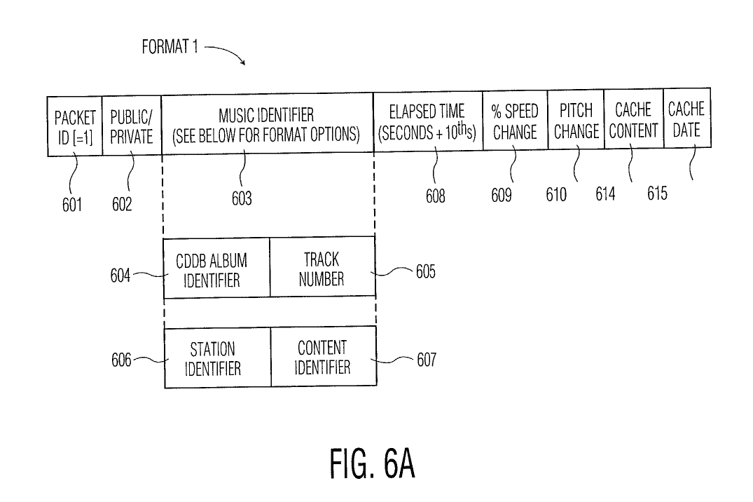

The control software 403 is further described in the flow chart of FIG. 5. At box 501, the software takes the meta-information from the stream (as detailed in the description for Diagram 2) to look up what music is currently being streamed. At 502, the identifier is compared with the contents of the Jukebox storage 407, using the directory 408 in the jukebox 406, to see if this or similar music is already stored locally.

If the music being streamed or an acceptable substitute therefor is already locally stored, then the control software does the following:

At 503, sends a signal back to the web server, over the Internet, using the IP Link Software 401. This instructs the server 102 to stop sending the music (B) in the stream to this listener (as described in FIG. 3);

At 504, instructs the mixer 411 in the listener to select the inputs referenced input1 and input3; and

At 505, instructs the Jukebox module 406 to start playing the appropriate content, using the status information (mentioned in the description for Diagram 3) to correctly substitute the local copy for the streamed copy.

If the music being streamed or a suitable replacement (e.g., based on style or performing artist, etc.) is not currently stored locally, then the control software has the option to start the Jukebox module recording the stream. The decision at 506 whether to do this will be based on the meta-information that is sent in the stream itself, i.e., the station has the option to request that the listener store the current content. However, this may not be totally at the control of the streaming device, since the jukebox is not necessarily under control of the streaming receiver. If the jukebox is a separate product from the streaming receiver, such control would likely be absent. Similarly the consumer may configure the jukebox to deny storage access to the streaming receiver. However, if this station does have the ability to request storage in the jukebox, then the control software does the following:

At 507, instructs the Jukebox module 406 to start recording the current content;

At 508, inserts into the directory 408 of the jukebox 406 the identifier for the content (sent in the meta-data with the content) to allow the content to be retrieved some time later; and

Instruct the mixer 411 to use inputs referenced input1 and input2.

Decompressors 404 and 405 receive the compressed digital streams and decompress them. There are two of these elements required for the listener, one for the DJ stream (A) and one for the music (B).

The mixer 411 takes the streams, input1 and input2 from the station and input3, from the local jukebox. The mixer then combines the signals into one digital audio stream, ready for conversion back to analog audio at 412. The mixer has the capability to fade the appropriate source for the music in or out, under the control of the Control Software 403, as described above. A mixer is a common component. Mixing is done either in the digital or analog domain and simply consists of the addition of the value of each of the digital inputs to the mixer together, to create a single digital signal. One example of a hardware mixer is the found in the Intel AC-97 chip architecture, see http://developer.intel.com/ial/scalableplatforms/audio commonly found inside PCs.

The digital-to-analog converter 412 is of a standard type, and converts the digital signal back to analog. In order to provide sufficient power amplification to drive the loudspeaker, so the user can hear the content sent by the station, a power amplifier stage, not shown, would probably have to be added.

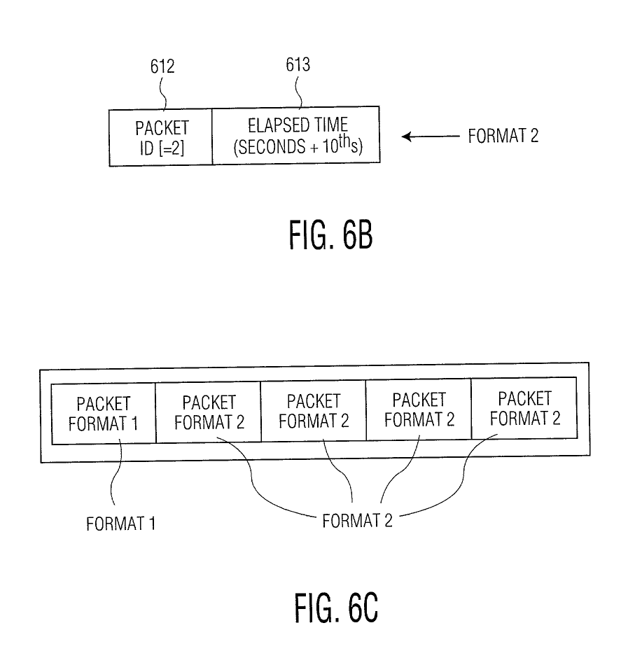

FIGS. 6A and 6B show a data format of data to be provided by box 207, in which the fields are defined as indicated in the table below. While a particular data format is described here, those of ordinary skill in the art might devise any number of alternative data formats usable in the invention.

| Ref. | | |
|---|---|---|
| # | Field Name | Purpose |
| 601, | Packet ID | Allows the listener to identify what fields are in this packet |
| 612 | | |
| 602 | Public/Private | Indicates whether the Music Identifier comprises CDDB Identifier + |
| | | Track Number or Station Identifier + Content Identifier |
| 603, | Music Identifier | This is a value that uniquely identifies the music that is currently |
| 613 | | being sent in the B stream from the server. The contents of the field |
| | | depend on whether the music is unique to the station (Private) or is |
| | | a track from a commonly available CD (Public). |
| 608 | Elapsed Time | This field holds a value indicating the time elapsed since the start |
| | | of the track. The value indicates the time that will have elapsed |
| | | assuming that the play speed is normal (i.e., % Speed Change = 0). |
| | | The time is preferably measured in 10^{th} of a second, i.e., a value of |
| | | 105 in this field would mean 10.5 seconds |
| 609 | % Speed Change | The value of the speed change for the music. It is preferably |
| | | expressed as a percentage of the original speed. For instance, a |
| | | value of −1 would mean a 100 second piece of music would be |
| | | played in 99 seconds (−1% of 100 seconds = 100 seconds × (99/100). |
| 610 | Pitch Change | Expresses a change in the playout pitch of the music in Hertz. This |
| | | should be applied after the % Speed Change. |
| 604 | CDDB Album | The identifier for the album, as would be used for the CDDB |
| | Identifier | service. Can be substituted for 603 in conjunction with 605 |
| 605 | Track Number | The track number from the disc. |
| 606 | Station Identifier | A unique value identifying this station. The value could be |
| | | administered by a central agency, to assure no two stations have the |
| | | same ID. Alternatively a URL for the station could serve as a |
| | | unique identifier. Can be substituted for 603 in conjunction with |
| | | 607. |
| 607 | Content Identifier | An identifier administered by this station to uniquely identify the |
| | | content, from all the content that it currently outputs. |
| 614 | Cache Content | A flag that is true if the content of stream B should be cached, else |
| | | it is set false |
| 615 | Cache Date | The number of days for which the content should be cached. This |
| | | allows the listener to identify content that is no longer needed and |
| | | can therefore be removed, to recover space in the jukebox |

The format of FIG. 6a, FORMAT 1, contains all of the required fields to identify the music currently being streamed. This longer packet should be sent once or twice a second. The packet format of FIG. 6B, FORMAT 2, is much smaller and contains only the timestamp information, allowing the listener to synchronize its local playout with the streamed content, to allow for a seamless switch over in the listener. This shorter packet should be sent repeatedly, every 10^{th} or 5^{th} of a second. The stream in that case would look something like FIG. 6C, which includes several instances of FORMAT 2 for each instance of FORMAT 1. By only sending the larger packet once or twice a second, the bandwidth required for the C channel is kept low.

Video Implementation

While the detailed description has been framed in terms of Internet radio and audio content, it is equally applicable to other types of content such as video.

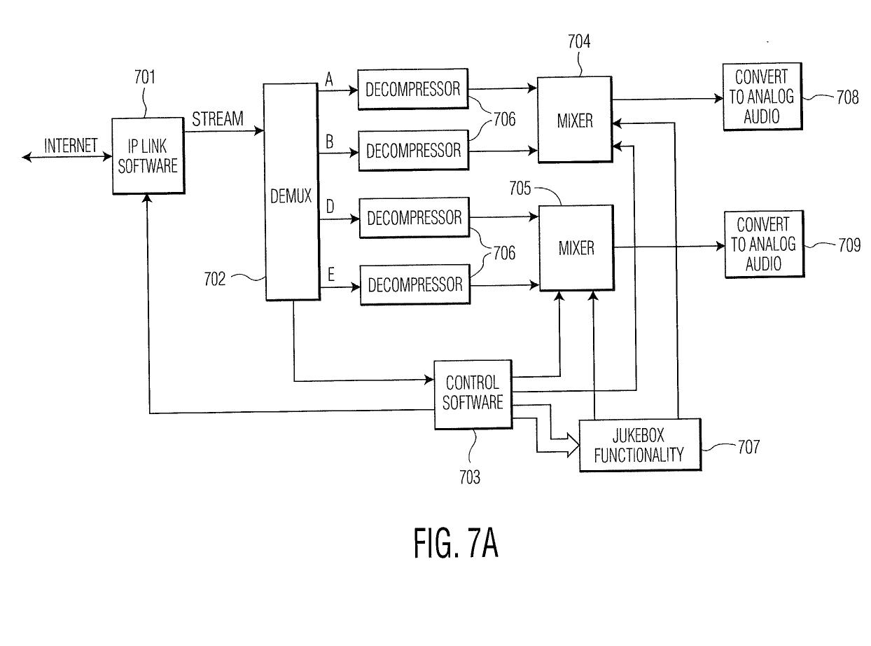

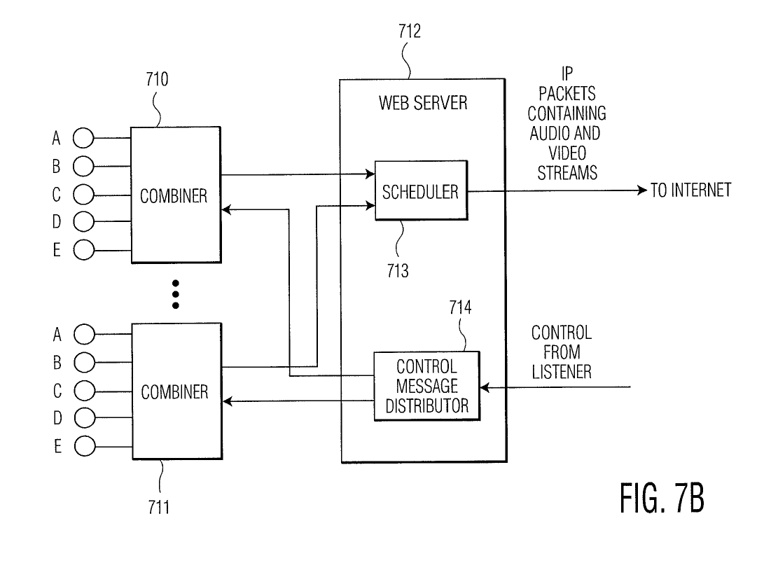

FIG. 7b shows a transmitter, analogous to FIG. 3, according to the invention in which both audio and video data are present. In this case, there are five data streams, A, B, C, D, and E. Streams A and B, as before, correspond to pre-recorded audio content and studio audio content, respectively. Streams D and E correspond to pre-recorded video content and studio video content, respectively. Stream C corresponds again to descriptor data, which is formatted mutatis mutandis to allow the listener to determine whether to substitute local data for the pre-recorded portion of the video data. The five streams, A, B, C, D, and E are separately compressed, then combined by multiplexers 710-711. As before, There must be a separate multiplexer for each listener, though for compactness of the drawing only two are shown. The scheduler 713 determines an order of presentation of data to the Internet. The control message distributor 714 distributes indications from the listener of whether streams A and/or D are needed, or whether local content can be substituted for one or the other or both.

FIG. 7a shows a listener device, analogous to FIG. 4, for the video situation. A stream produced by the device of FIG. 7b arrives at the IP link software 701, which in turn provides it to the demultiplexer 702. Then the separate compressed streams A, B, D, and E are recovered and supplied to the decompressors 706, which supply uncompressed versions to mixers 704 and 705. The mixers 704 and 705 choose streams A and D or local content from the jukebox functionality 707, under control of the control software 703. There are a number of possible permutations here.

All streams A, B, D, and E might be present and as a result all content might come from the Internet.

Streams B, D, and E might be present. In this case, locally stored audio content would be mixed with studio audio content B from the Internet to provide the audio output at 708, where the actual audio is produced for the human user. In this case, all video content would be supplied from the Internet, and provided user at 709, where the actual video is produced for the human user.

Streams A, B, and E might be present. In this case, all audio content would be supplied from the Internet, but some video content would be supplied locally.

Only B and E might be present, in which case both some video and some audio content would be supplied locally.

From reading the present disclosure, modifications will be apparent to persons skilled in the art. For example, the tag to identify a certain piece of streamable content could be sent somewhat ahead of time with respect to the streamable content, so as to enable the user's home equipment to identify and retrieve the matching content if stored locally. An electronic program guide (EPG) approach can be used to implement this, for instance. Typically, however, in the DJ or studio chatter example discussed above, music content on the one hand and studio chat or commercials on the other hand alternate. Sending the descriptor of the content with the studio chat stream gives time to the user's home network to decide whether or not locally stored content is to be played out. Such modifications may involve other features which are already known in the design, manufacture and use of Internet radio and content streaming and which may be used instead of or in addition to features already described herein. Although claims have been formulated in this application to particular combinations of features, it should be understood that the scope of the disclosure of the present application also includes any novel feature or novel combination of features disclosed herein either explicitly or implicitly or any generalization thereof, whether or not it mitigates any or all of the same technical problems as does the present invention. The applicants hereby give notice that new claims may be formulated to such features during the prosecution of the present application or any further application derived therefrom.

The word “comprising”, “comprise”, or “comprises” as used herein should not be viewed as excluding additional elements. The singular article “a” or “an” as used herein should not be viewed as excluding a plurality of elements.

What is claimed is:

1. A system for providing a transport data stream via a data network to a receiver of an end-user, the system having:
a first generator adapted to generate a first content stream;
access to data for generating a second content stream;
a second generator adapted to generate a descriptor for the second content stream;
a multiplexer adapted to transmit a first type of transport data stream including the first content stream, second content stream, and the descriptor, or a second type of transport data stream from which the second content stream is absent and comprising the first content stream and the descriptor, in response to the receiver indicating a presence of content stored locally at the receiver and corresponding to the second content stream.

2. A receiver for processing content data streamed from a transmitter via a data network, the receiver comprising:
a data avenue adapted to receive and/or transmit data;
a processing unit adapted to perform the following operations:
detecting an incoming transport data stream at the data avenue;
separating out at least a first content stream and control data from the transport stream;
under control of the control data, either mixing the first content stream with at least one second content stream from the transport data stream, or mixing the first content stream with a content stream from a source local to the receiver; and
providing to the data avenue an indication adapted to enable the transmitter to provide an appropriate transport content stream.

3. The receiver of claim 2, wherein the processing unit is further adapted to perform the following operation: under control of the control data, recording at least part of at least one of the first and second content streams for later use as the local content stream.

4. The receiver of claim 2, wherein the processing unit is adapted to record the control data.

5. The receiver of claim 2, wherein the control data comprises a recording identifier, a play speed indicator, and elapsed time information.

6. An article of manufacture comprising a transport content stream embodied as at least one physical structure or phenomenon, the article comprising:
a content stream including at least a portion of a desired unicast; and
control data adapted to enable a user to mix the content stream with locally stored data to recreate the desired unicast.

7. The article of claim 6, wherein the control data is further adapted to enable the user to record the portion for later playback, such recording being substantially simultaneous with current playback.

8. The article of claim 7, wherein the control data comprises a recording identifier, play speed, and elapsed time information.

9. Software for producing content for being streamed to a user over a data network, the software comprising code for performing the following operations:
enabling to generate at least a first content stream;
enabling to provide at least one descriptor;
enabling to transmit to the user either a first type of transport data stream including the first content stream, at least a second content stream and the descriptor, or a second type of transport data stream from which the second content stream is absent and including the first content stream in response to receipt of an indication of content being available local to the user and corresponding to the second content stream.

10. The software of claim 9, wherein the descriptor comprises control data for enabling the user to recreate a combined unicast including the first content stream and the locally available content.

11. The software of claim 10, wherein the control data comprises a recording identifier, play speed, and elapsed time information.

12. The software of claim 9, wherein the control data is further adapted to enable the user to record the portion for later playback, such recording being substantially simultaneous with current playback.

13. The software of claim 9, wherein the code enables recording of the control data.

14. The software of claim 9, wherein a plurality of simultaneous transport streams are provided, at least two of the transport data streams differing in content in accordance with user requirements.

15. Software for processing content data received from a transmitter over a data network, the software comprising code adapted to perform the following operations:
detecting a transport stream at a data avenue;
separating out from the transport stream at least a first content stream and control data;
under control of the control data, either mixing the first content stream with at least a second content stream from the transport stream; or mixing the first content stream with a local content stream;
providing to the data avenue a local content indication adapted to enable a transmitter to provide an appropriate transport content stream.

16. The software of claim 15, further adapted to perform the following operation: under control of the control data, recording at least part of at least one of the first and second content streams for later use as the local content stream.

17. The software of claim 16, wherein the control data comprises a recording identifier, play speed, and elapsed time information.

18. The software of claim 15, enabling to record the control data.

19. A method for providing a transport content stream comprising:
generating at least a first content stream;
generating at least one descriptor;
responsive to user input, transmitting one of:
a first type of transport data stream including the first stream and at least one second stream and the descriptor, in response to a first type of user input indicating lack of user stored content corresponding to the at least one second data stream; and
a second type of transport data stream including the first stream and the descriptor, in response to a second type of user input indicating presence of user stored content corresponding to the at least one second stream.

20. The method of claim 19, wherein the descriptor comprises control data for enabling the user to recreate a combined unicast including the first content stream and the user stored content.

21. The method of claim 20, wherein the control data comprises a recording identifier, play speed, and elapsed time information.

22. The method of claim 19, wherein the descriptor comprises control data for instructing the user to record at least a portion of the first and/or second stream for local caching in a user device simultaneously with playback of that portion by the user.

23. The method of claim 19, wherein a plurality of transport content streams are provided simultaneously, at least two of the transport content streams differing in content in accordance with user requirements.

24. A method for processing streamed content, comprising:
detecting a transport data stream at a data avenue;
separating out at least a first content stream and control data from the transport stream;
under control of the control data, either mixing the first content stream with at least one optional second content stream from the transport data stream for playback; or mixing the first content stream with a local content stream for playback;
providing, to the data avenue, a local content indication adapted to enable a transmitter to provide an appropriate transport content stream.

25. A method of enabling, via a data network, a client to process content, the method comprising:
determining if the client has a first part of the content locally available;
transmitting a transport stream comprising another part of the content and control data, wherein the control data enables the client to mix the first part with the other part.
